(19) United States
(12) Patent Application Publication
(10) Pub. No.: US 2025/0162729 A1
(43) Pub. Date: May 22, 2025

(54) Engine Guard

(71) Applicant: Loretta Christmon, Columbia, SC (US)

(72) Inventor: Loretta Christmon, Columbia, SC (US)

(21) Appl. No.: 18/942,717

(22) Filed: Nov. 10, 2024

Related U.S. Application Data
(60) Provisional application No. 63/600,657, filed on Nov. 18, 2023.

(51) Int. Cl. B64F 1/36

(52) U.S. Cl. CPC B64F 1/36

(57) ABSTRACT

According to an aspect of the present invention, there is provided a mobile, free-standing, no-contact aircraft engine intake shield that is cover and suitable for use with most contemporary commercial aircraft. This design implementation provides protection for ground personnel from being ingested into the engine of variety of aircraft, in a portable, affordable, and easy-to-transport package.

### BACKGROUND

The presented utility is used for protecting ground personnel from the intakes of aircraft engines.

Commercial aircraft engines are powerful pieces of equipment that draw substantial amounts of air into their intakes while the engine is running, creating a vacuum effect. This can cause nearby debris and, more concerningly, personnel to be pulled into the intake and enter the engine's fan blade and other moving parts. This poses a serious safety risk for ground personnel and multiple occurrences of such harm have been documented during the history of recent commercial aviation.

There are several styles of engine intake covers and plugs that currently exist. Rigid conical mesh covers made from metal or plastic are simple in design and relatively low-cost, but require a tailored design for every engine and typically require additional equipment to install due to their size and weight, such as a crane. Large fabric covers that attach to the exterior of the engine are low-cost and can accommodate some variation in engine size, but still require some tailoring, can be difficult to install, and also run the risk of being sucked deep into the mechanicals of the intake if not properly secured. Large foam plugs are easier to install, but require a tailored design for every engine and can be more expensive. None of these solutions address the issue of the safety for ground personnel, however. The fabric and plug style covers are only installed when the engine is not running. And the rigid conical mesh covers are typically used for tests or experiments, not an aircraft that is flight ready or on a runway.

Thus, solutions which protect ground personnel and others from the risk of death and serious injury due to contact with aircraft engines are urgently needed.

### SUMMARY OF INVENTION

Therefore, the present invention is a mobile, free-standing, no-contact shield is disclosed to protect ground personnel from being ingested into the intake of a running engine. The shield includes a screen that is large enough to span across the majority of the intake's opening for a variety of common commercial aircraft. The cover has rotating, lockable wheels that allow it to roll across hard surfaces such as tarmac asphalt, cement pathways, and other common airport surfaces.

### BRIEF DESCRIPTION OF THE DRAWINGS

FIG. 1 illustrates a front perspective view of an engine guard according to an embodiment of the present invention.

FIG. 2 illustrates a back perspective view of an engine guard according to an embodiment of the present invention.

### DETAILED DESCRIPTION

Generally, embodiments of the present invention comprise a rigid, semi-rigid, or soft goods screen which is configured to be perpendicular to the ground so as to cover an aircraft engine and a stabilizer which stabilizes the screen in position, both of which can be made from metals, plastics, composites, or other suitably robust material, or any combination of these materials. The screen and stabilizer can connect at a hinge which allows the stabilizer to pivot up and out of the way to reduce the footprint of the embodiment for easier transport and storage. The screen shall be sufficiently large so as to span enough of the intake of most common aircraft to prevent ground personnel ingestion; such aircraft include the Boeing 737, Boeing 727, Boeing 777, Airbus A330, Airbus A350, and other contemporary jet aircraft (although other embodiments could be configured to operate with propellor aircraft which pose similar risks of harm from contact). A supporting arm can be used to brace the stabilizer when in the stationary configuration and may be removed or articulated out of the way in the mobile configuration. Wheels can be attached to the underside of the screen and stabilizer, spaced sufficiently apart so as to provide adequate stability while in both the stationary and mobile configurations. Wheels may be made from rubber, plastic, or any other suitable material, and may be attached to the screen and stabilizer using fasteners, welding, or other appropriate methods. They will swivel or be omnidirectional in design and have a locking feature to prevent movement when desired. Handles can be mounted in several locations on the screen that are conducive to manually moving and positioning the embodiment, and may be attached using fasteners, welds, or other appropriate methods. Lights can be mounted in several locations on the screen and stabilizer to ensure adequate visibility from any necessary viewing angles, and may be attached using fasteners, adhesives, or other appropriate methods. A tow hitch can extend from the front of the screen, allowing for fast and easy transport using other airport equipment such as luggage or aircraft tugs, and may be made from metals, plastics, composites, or any other suitably robust material.

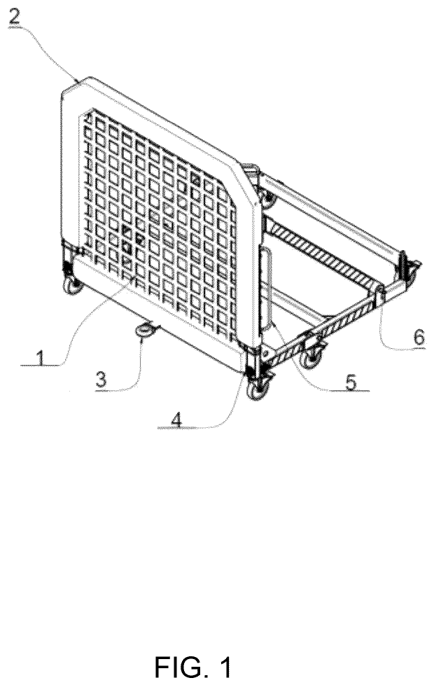

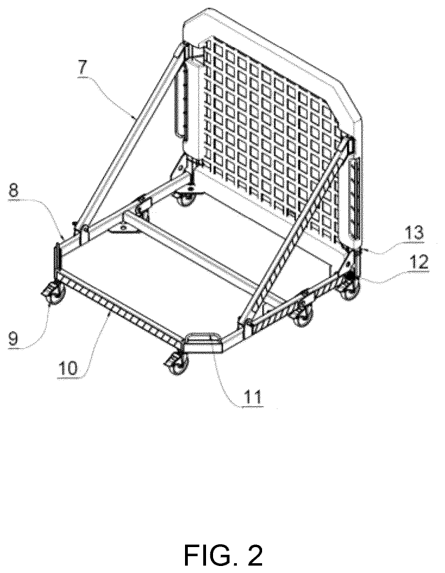

In FIG. 1 illustrating a front perspective view of an engine guard according to an embodiment of the present invention and FIG. 2 illustrating a back perspective view of an engine guard according to an embodiment of the present invention, the following reference numerals are notated:

Net 1 is generally made of a soft and strong textile material.

Cushion 2 can be made of a soft foam material to protect persons from severe injuries.

Drawbar ring 3 can be provided for ease of manipulation.

Traffic reflector 4 can be provided for ease of visibility particular in dark conditions.

Handle 5 can be used for fine positioning by hand.

Quick release pin 6 enables easy folding and unfolding.

Support arms 7 can be used for reinforcement and fixating the embodiment when unfolded.

Base stabilizer 7 increases stability in an unfolded state and gives support to the structure.

Casters 9 can be provided with brakes to fix the embodiment in place.

Reflective stickers 10 can be used for visibility in dark conditions.

Base handle 11 can be used for fine hand position adjustment.

Traffic reflector 12 can be used for ease of visibility from the sides in dark conditions.

Elastic rope 13 connects the net and screen frame, with elasticity reducing impact force.

The engine guard folds down while in use and folds up for transport and storage to minimize footprint.

A collapsible arm extends between the screen and stabilizer when the shield is deployed.

Some embodiments add shock absorbers to the two arms.

In a preferred embodiment, the screen should be soft to maximize its dampening effect.

A preferred embodiment has a frame made from steel tubes, i.e., a welded steel tube frame.

A preferred embodiment has a hinge with a vertical axis, allowing the arm to fold to the side.

In a preferred embodiment, these arms could be made from a single piece, without a joint in the middle, providing a stronger, more robust, and simpler solution.

The handles could be simple bent steel rods positioned at the corners, providing an accessible solution from all sides.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A protective shield configured to an aircraft engine, comprising:
A rigid or semi-rigid screen large enough to cover enough of the intake orifice of an aircraft engine to prevent ingestion of ground personnel;
A frame outlining the screen;
A folding stabilizer coupled to the screen that increase the footprint of the protective shield to ensure that it has adequate steadiness while in use;
Wherein intakes that does not make contact with the engine itself, and resides on the ground, runway, tarmac, or any other surface where an aircraft resides.

2. The protective shield of claim 1, further comprising heels, casters, or other rolling mechanisms or equipment which facilitate the transportation of the assembly.

3. The protective shield of claim 2, further comprising a tow hitch, arm, or other mounting point compatible with contemporary airport mobility equipment.

4. The protective shield of claim 1, further comprising handles, grips, pull points, or other hardware configured to serve as a interface for a human operator to grab, pull, push, position, and otherwise manipulate the assembly.

5. The protective shield of claim 1, further comprising lights, signals, reflectors, or other visual indicators of sufficient brightness and visibility to ensure that airport personnel, whether they be on the ground or in vehicles, can detect the assembly and avoid potential collisions.

6. The protective shield of claim 1, wherein the frame is made of steel tubes.

7. The protective shield of claim 1, further comprising one or more elastic ropes connecting the screen and the frame.

8. The protective shield of claim 1, further comprising one or more collapsible arms extending between the screen and stabilizer when the shield is deployed.

9. The protective shield of claim 8, further comprising one or more shock absorbers on the one or more collapsible arms.

10. A method of using the screen according the claim 1, comprising:
transporting the protective shield to a location adjacent to an aircraft engine; and
deploying the screen in front of the aircraft engine.
